(19) United States
(12) Patent Application Publication
(10) Pub. No.: US 2012/0008663 A1
(43) Pub. Date: Jan. 12, 2012

(54) OFDM Synchronization and Signal Channel Estimation

(76) Inventor: Donald L. Schilling, Palm Beach Gardens, FL (US)

(21) Appl. No.: 12/831,345

(22) Filed: Jul. 7, 2010

(51) Int. Cl. H04L 27/28; H04B 1/707; H04L 27/06; H04L 27/00

(52) U.S. Cl. 375/146; 375/295; 375/260; 375/340; 375/E01.002

(57) ABSTRACT

OFDM synchronization and signal channel estimation is accomplished by adding pilot signals to the outputs of OFDM encoders, i.e. after encoding of data/symbols, in a spread spectrum wireless communication system utilizing uniquely designed OFDM transmitters, OFDM receivers and OFDM systems and methods.

### BACKGROUND OF THE INVENTION

1. Field of the Invention

The present invention relates to spread spectrum wireless communication and, more particularly, to methods, systems, transmitters and receivers for orthogonal frequency division multiplexing (OFDM) communication over a fading, multipath channel with improved synchronization and signal channel estimation.

2. Brief Discussion of the Related Art

OFDM communications over fading, multipath channels typically incorporate pilot signals which, as used herein, include pilot tones (frequency components) or pilot codes, as well as other transmitted signals providing information identifying a source of transmitted data and/or estimating channel parameters. In order to synchronize incoming signals to a locally generated synchronizing signal and in order to estimate channel parameters which vary with time, some timing information must be sent along with the transmitted data. Some prior art sends known “training” signals at the start of each burst of transmitted data. Other prior art sends “pilot” signals in several of the data channels. Other prior art employ both training and pilot signals. Problems become severe in mobile environments since channel changes depend, in part, on the motion of a remote user.

A typical prior art OFDM communication system utilizing an OFDM/MIMO transmitter is shown in FIG. 1 and an OFDM/MIMO receiver is shown in FIG. 2. The prior art OFDM/MIMO transmitter shown in FIG. 1 includes a data input 30 supplied to a coding and interleaving circuit 32 which supplies the coded and interleaved data to a demultiplexer 34 for demultiplexing the coded and interleaved data into a number, N, of spatial channels denoted by numbers CH1 . . . CHN with only channels CH1 and CHN shown in FIG. 1 with the understanding that each channel has the same arrangement of circuits whereby the signals from each channel are supplied to a plurality of transmit antennas TA1 . . . TAN, respectively. The demultiplexed, coded and interleaved data in each spatial channel is supplied to a series-to-parallel converter S/P, and the outputs of the converter S/P are supplied to a K-point encoder such as an IFFT encoder. The inputs to each IFFT encoder have K lines corresponding to the number of spread spectrum subchannels. The inputs include a pilot/training signal such that each IFFT encoder receives one or more pilot/training signals. The IFFT encoder generates K subchannels, shown as 1, 2 . . . K, for the coded and interleaved data, the pilot and training signals and any other signals to be sent. If the data rate supplied to S/P is f_{D}, each of the K subchannels will have a bandwidth of approximately (taking into account other signals sent) f_{D}/K such, that at the output of the IFFT encoder, the input data changes once every K/f_{D} seconds. Similarly, the pilot/training signals are generated once for every K/f_{D} seconds such that chip code modulation of the pilot/training signals changes at a slow rate, i.e. at the per subchannel rate. The output from each parallel—to serial converter P/S which follow the IFFT is inputted to a transmit antenna.

A typical prior art OFDM/MIMO receiver is shown in FIG. 2 and includes a plurality of receiver antennas denoted as RA1 . . . RAN, it being noted that the designation N has been used for simplicity purposes. In order for the OFDM/MIMO receiver to undo the transmitting operations provided by the OFDM/MIMO transmitter of FIG. 1, each receiver antenna receives all of the transmitted signals; however, the transmitted signals have traveled over different channels and, therefore, are characterized by different channel transfer functions. Each receiver antenna supplies received signals to a respective serial-to-parallel converter S/P 1 . . . N which supplies K signals 1 . . . K to an FFT decoder 1 . . . N to undo the IFFT encoding. The K outputs of each FFT decoder are supplied to a parallel-to-serial converter P/S 1 . . . N with the outputs of each converter P/S 1 . . . N supplied to a data processor 36 that performs deinterleaving, time diversity, space diversity, decoding, channel estimation and synchronization, any other tasks and finally multiplexing of the estimated spatial streams required to provide an estimate of the transmitted data. Changes in the FFT outputs occur at the rate of K/f_{D}; and, only after the parallel-to-serial conversion at P/S does the data rate revert back to the original data rate f_{D}. Accordingly, it should be appreciated that all operations in prior art OFDM/MIMO communication systems occur at the rate f_{D}/K which defines the time required to load all input information into the K subchannels of the transmitter's IFFT referred to as the symbol time T.

Control of the operation of the prior art transmitter of FIG. 1 and the prior art receiver of FIG. 2 is typically synchronized by a synch clock.

Ozdemir, M. K., in an article entitled, “Channel Estimation of Wireless OFDM Systems”, IEEE Communications Magazine, 2007, illustrates two techniques employed to estimate a multipath channel. The first technique is to send a known training sequence of symbols at the start of each packet. Using the known sequence, the channel can be estimated. In a multi-user system, where every user transmits to the base station, the base station provides each remote user with a temporary training sequence, so the base station can synchronize to each user. The second technique consists of sending an orthogonal sequence in several specified channels of each of the multi-channel OFDM signals such that each receiver is able to identify which antenna transmitted the signal. Thus, if the IFFT encoder processes 64 symbols simultaneously, there are 64 rows containing data symbols, training symbols, and pilot symbols. The training symbols have replaced data symbols and, as a result, cause a decrease in data rate. To minimize this effective reduction in data transmitted per unit of time per unit bandwidth, the number of training symbols is made as small as possible, typically 10%. However, if the channel changes, during the time between training symbol bursts, the calculated channel parameters will be in error.

Another technique is to continuously send a pilot signal in several of the multichannels used in the OFDM transmitter. The sending of several pilot signals, rather than a single pilot signal, is required since the channel fades as a result of the multipath signals. The fading is frequency sensitive and can extend over several of the subchannels. Fades of 5 MHz are typical in many environments. The number of pilot signals, usually 4, 6, or 8, depending on the overall bandwidth, is chosen to yield pilot signals which fade in an uncorrelated manner with one another. The pilot signal may be modulated and provide synchronization as well as aid in channel estimation. In order to avoid a significant decrease in data rate, the pilot signal may be transmitted intermittently. The pilot signal changes at the IFFT encoder subchannel rate, f_{D}/K. Hence, variations in the channel occurring during the symbol time (T=K/f_{D}) are not detected. Additionally, variations of the channel occurring when no pilot or training sequence is occurring are not detected.

U.S. Patent Application Publication No. 2007/0025236 to Ma, et al, and U.S. Pat. No. 7,145,940 to Gore et al and U.S. Pat. No. 7,457,376 to Sadowsky are representative of other prior art techniques that have various disadvantages. In the technique disclosed in Ma et al, pilot and training sequences are used for coarse and fine synchronization but are not sent during the time that the data is transmitted. Thus, changes in the channel during the time of data-only transmission are not detected. In the technique disclosed in Gore et al, the pilot is multiplexed with the data prior to the IFFT conversion to OFDM. Thus, pilot signals are sent over several, presumably uncorrelated, subchannels while the data is sent over the other subchannels. That is, pilot signals and data are not sent over the same channel. Additionally, the bandwidth of each pilot signal is equal to the subchannel bandwidth. Accordingly, synchronization and channel estimation are not acceptably provided in a rapidly fading channel environment. In Sadowsky, it is assumed that the channel can be perfectly measured. The input signal possibilities are compared to the possibilities that would be present in a line of sight, non-fading, no noise channel, and the one that is selected is the one that minimizes the mean square error. However, in a real life situation, the wireless channel does fade.

The IEEE Standard 802.16, intended for cellular type operation, includes 8 pilot subcarriers in each spatial stream. The subcarriers are each modulated using a different PN sequence. The sequences transmitted over the different antennas (the spatial streams) employ different, but orthogonal, periodic sequences. Since the time duration of each spatial stream from transmit to receive antennas differ, the spatial streams are not orthogonal at reception. While the separation of pilots are an attempt to minimize the fading being correlated over many of the pilot subchannels, that need not be the case. Indeed, indoor, where there is a considerable amount of fading, a large number of pilots can be cancelled resulting in poor channel estimation and poor frequency synchronization.

The IEEE Standard 802.11n illustrates the use of 4 pilots in a 20 MHz band and 6 pilots in a 40 MHz band. Different, orthogonal codes are used for each antenna. The code symbol occurs at the same rate as the data symbol.

### SUMMARY OF THE INVENTION

A primary aspect of the present invention is to improve synchronization and signal channel estimation in an OFDM communication system by adding pilot signals to OFDM encoded signals at a transmitter to produce transmit signals formed of pilot signals added to OFDM encoded signals for transmission to a receiver.

In a further aspect, the present invention employs a direct sequence spread spectrum signal spread over the entire available frequency band where a pilot signal (code) is added to the output of each encoder (e.g. IFFT, multichannel orthogonal modulation system, or the like) of an OFDM transmitter such that the pilot code is not encoded (e.g. by the IFFT). As a result, the pilot code (chip rate) is equal to the total available bandwidth as opposed to the prior art where pilot codes can be changed at the symbol/data rate which is equal to the total available bandwidth divided by the total number of subchannels (i.e. the subchannel bandwidth) transmitted by each antenna of the OFDM transmitter.

In another aspect, the present invention relates to transmitters, receivers, methods and systems for OFDM wireless communications where pilot signals for synchronization and signal channel estimation are added to data signals after OFDM encoding thereof to produce a combined signal for transmission with a number of subchannels carrying data and at least one subchannel carrying the pilot signals.

In an additional aspect, the present invention relates to any OFDM (spread spectrum) communications, including MIMO, where at a transmitter pilot signals are added to OFDM encoded data signals after OFDM encoding and at a receiver the pilot signals are split from the received signals for detection in a path parallel to decoding of the OFDM encoded data signals.

Some of the advantages of the present invention include improvement of synchronization in an OFDM communications system by as much as a factor of K where K is the number of subchannels, improvement of channel estimation in an OFDM communication system due to estimating channel parameters up to K times during each transmitted symbol (sampling interval) as opposed to estimating channel parameters once per transmitted symbol as in the prior art referenced above and as is prescribed in the IEEE Standards 802.11 and 802.16 referenced above. By using a wideband direct sequence spread spectrum technique, some of the advantages are that, if the data rate to the IFFT encoder is f_{D} and there are K subchannels, there are f_{D}/K encoded symbols transmitted per/sec, and the spread spectrum system chip code is transmitted at the rate f_{C} which is equal to f_{D}. Therefore, there are K chips transmitted/IFFT input symbol as compared to prior art systems where only one chip/IFFT input symbol is transmitted, such that synchronization can be improved by a factor of K with the present invention and channel estimation is significantly improved since the channel parameters can be estimated every K chips during each transmitted symbol (f_{D}/K) in marked contrast to estimating the parameters once per symbol for a short period of time during each burst of data as is currently prescribed in the IEEE Standards. Accordingly, the present invention overcomes the disadvantages of the prior art by providing correction substantially faster, where correction is increased essentially by a factor equal to the number of channels (subchannels) times the data rate.

Other objects and advantages of the present invention will become apparent from the following description of the preferred embodiments taken in conjunction with the accompanying drawings, wherein like parts in each of the several figures are identified by the same reference characters.

### BRIEF DESCRIPTION OF THE DRAWINGS

FIG. 1 is a block diagram of a prior art OFDM/MIMO transmitter.

FIG. 2 is a block diagram of a prior art OFDM/MIMO receiver.

FIG. 3 is a block diagram of an OFDM/MIMO wireless communication system with a multipath communication channel.

FIG. 4 is a block diagram of an OFDM/MIMO transmitter according to the present invention.

FIG. 5 is a graphical representation of the orthogonal nature of an OFDM spectrum.

FIG. 6 illustrates subchannels in available bandwidth.

FIG. 7 illustrates repetition of chip code.

FIGS. 8(a), (b) and (c) illustrates symbols being transmitted, codeword duration and number of chips per codeword, respectively.

FIG. 9 illustrates a multipath channel in which the present invention can be used.

FIG. 10 is a block diagram of an OFDM/MIMO receiver according to the present invention.

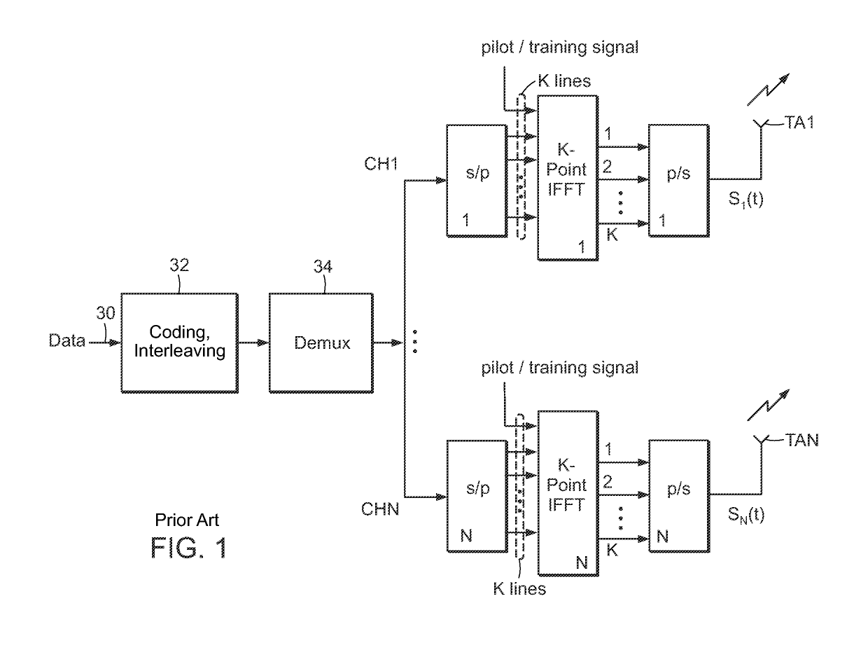

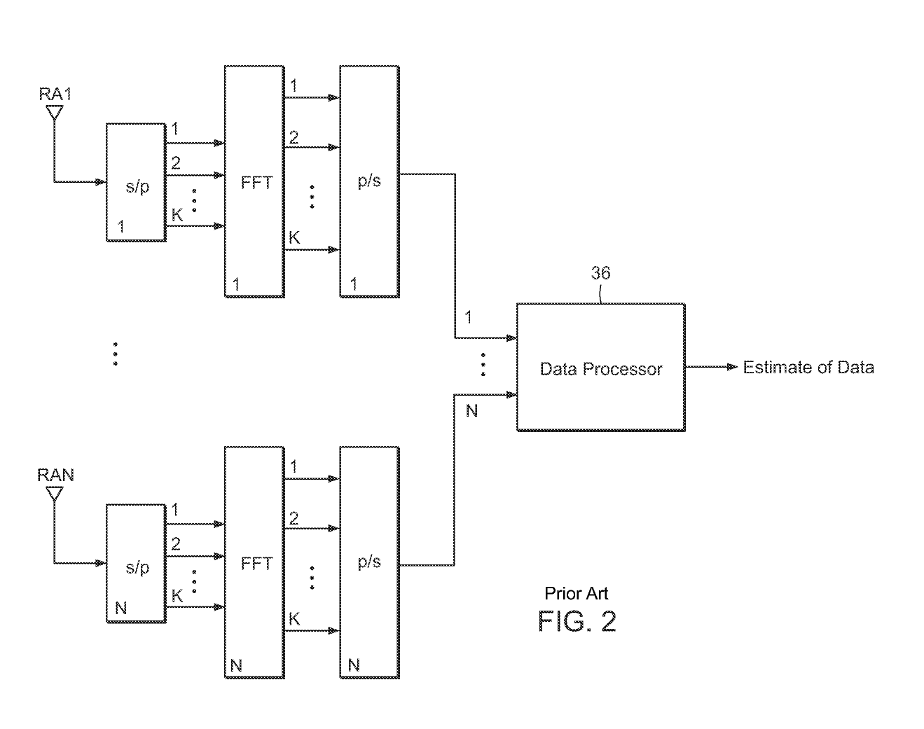

### DETAILED DESCRIPTION OF THE INVENTION

As used herein, “MIMO” means multiple antennas transmitting information from a transmitter into a wireless communications channel, and multiple antennas at a receiver receiving the information from the output of the wireless communications channel; “OFDM” means multicarrier, orthogonal, modulation wireless communication technology using a frequency-division multiplexing scheme as a digital multi-carrier modulation method with a large number of closely-spaced orthogonal sub-carriers used to carry data which is divided into several parallel data streams or channels, one for each sub-carrier, each sub-carrier being modulated with a conventional modulation scheme, such as quadrature amplitude modulation or phase-shift keying, for example, at a low symbol rate maintaining total data rates similar to conventional single-carrier modulation schemes in the same bandwidth; “IFFT” means an encoder using a Fourier Transform with a bandwidth B (where B=f_{D} and K subchannels such that the bandwidth of each subchannel is B/K, the Fourier Transform process occurring every T=K/B during which time K input symbols (a bit of data is a 1-bit symbol) of data representing the complex signals at each of K frequencies, are converted into K time waveforms (f(t)=ΣF(wᵢ)ejwᵢt), during each time interval: 0 to T where i=1, 2, . . . , K and f(t) is the output of the IFFT. F(wi) are the K input symbols (or bits) that are input to the IFFT in time T, each F(wᵢ) for i=1, 2, . . . K are fixed during each T sec interval, and are referred to as symbols); “FFT” means a decoder which achieves the inverse of an IFFT; “demultiplexer” means a device which takes input data and, in a prescribed manner, outputs the data in more than one parallel data stream; “pilot signal” means a modulated carrier sent on one or more of the subchannels of an OFDM signal which is usually modulated, with a binary sequence called a chip code; “chip code” means a binary sequence of bits chosen using a prescribed algorithm, for example Walsh functions, PN sequences and others, the PN sequence can be extended to be orthogonal to other extended PN sequences; “RAKE/Equalizer” means any technique employed in a receiver to combine multipath signals; “spatial data stream” means a data stream that is to be transmitted using a transmit antenna as well as one of the data streams received by a particular receive antenna; “multipath signal” means a signal emanating from a transmit antenna that travels in multiple directions simultaneously, depending on the shape of the antenna, such that when a multipath signal is received by a receive antenna, multiple copies, delayed and attenuated with respect to one another result; and “multipath channel” means a path a signal takes from a transmit antenna to a receiving antenna, noting that multipath channels change with time as a result of changes in the environment.

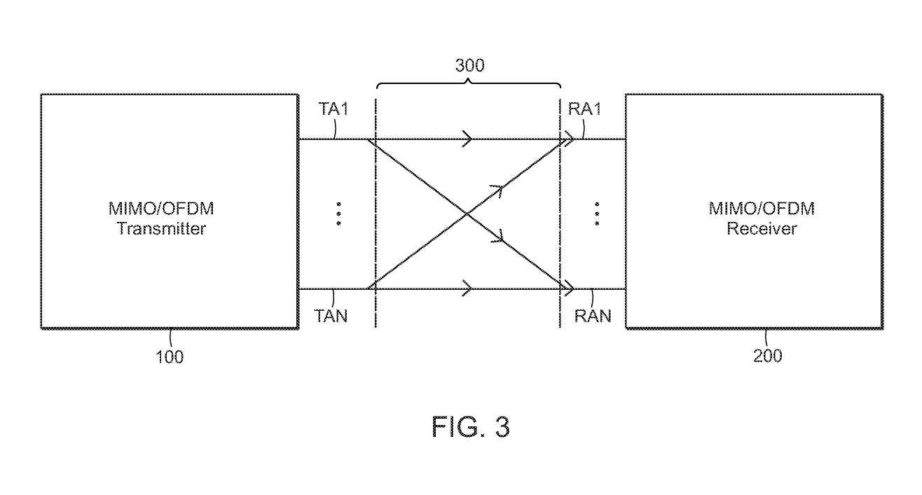

An OFDM wireless communication system according to the present invention includes, as shown in FIG. 3, at least one transmitter 100, at least one receiver 200 and a wireless multipath communication channel 300 between the transmitter and the receiver. Where the transmitter 100 is OFDM/MIMO it has multiple transmit antennas TA1 . . . TAN, and the receiver 200 has multiple receive antennas RA1 . . . RAN. FIG. 3 illustrates multipath transmissions in a simplistic manner. The present invention is described in connection with OFDM/MIMO wireless communication; however, it should be understood that the basic concept of the present invention (i.e. adding pilot signals to outputs of OFDM encoders as opposed to inputs of OFDM encoders) can be used in any OFDM (spread spectrum) communication system.

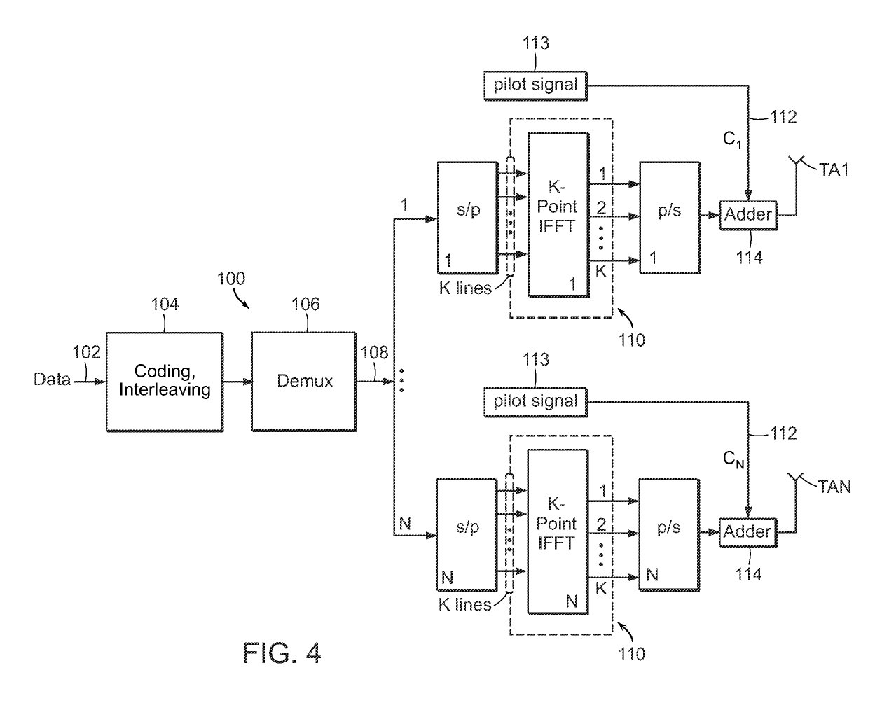

As shown in FIG. 4, in MIMO/OFDM transmitter 100, data 102 is coded for error control (FEC) and interleaved at 104, and the error control, interleaved signals are supplied to a MIMO demultiplexer 106 which has N spatial data signal outputs 108 (1 . . . N), one spatial data signal for each transmitter antenna TA1 . . . TAN. Each spatial data signal is OFDM modulated by an OFDM encoder 110, such as an IFFT where the data is demultiplexed to form K multi-channels (data encoded subchannels) for each of the OFDM encoders. Each of the K subchannels of each encoder is IFFT encoded and supplied to a parallel to serial converter p/s. The MIMO/OFDM transmitter thus produces encoded spatial signals 1 . . . N. Each spatial signal is added to a direct sequence spread spectrum (DSSP) pilot signal 112 generated by a pilot signal source 113 at an adder 114 forming N multi-channel spread spectrum (OFDM plus pilot signal) spatial combined signals. Each spatial combined signal is amplitude modulated (frequency translated) to the same radio frequency and input to a separate transmit antenna.

In summary each of the encoded signals, m₁, m₂, . . . , m_{N}, is a spatial signal since each signal is destined for a different transmit antenna, TA₁, . . . , TA_{N}. Each of the encoded signals is then added to a direct sequence spread spectrum pilot signal, c₁(t), . . . , c_{N}(t), forming N spatial signals. Each spatial signal is amplitude modulated (frequency translated) to the same radio frequency f₀, and input to separate transmit antennas. The transmitted signals are: s₁=m₁+c₁, s₂=m₂+c₂, s_{N}=m_{N}+C_{N}.

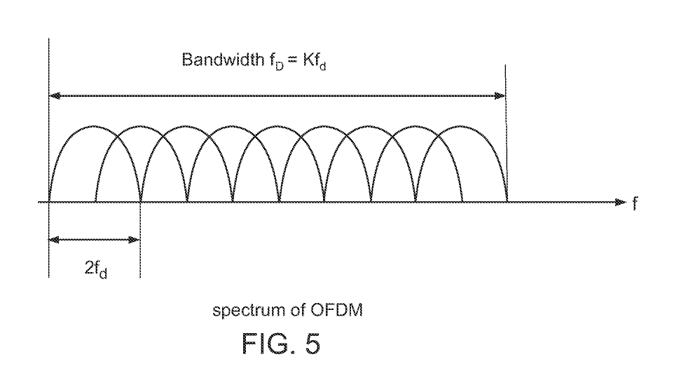

FIG. 5 shows the orthogonal nature of the OFDM spectrum. Note that the spectra of the adjacent subchannels overlap. However, it is well known that with a 50% overlap, as shown, the signals are still orthogonal. Thus, in OFDM, each of the subchannels has a bandwidth of b=2f_{D}. In practice this bandwidth is expanded to allow for jitter, and other uncertainties. The available bandwidth B is filled with K channels, where B=Kf_{D}, due to the 50% overlap shown in FIG. 5.

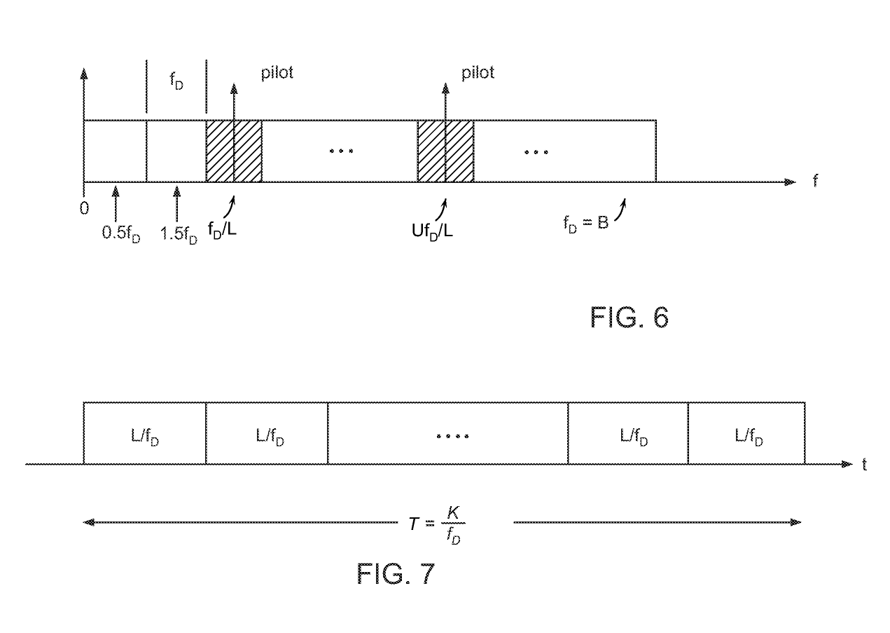

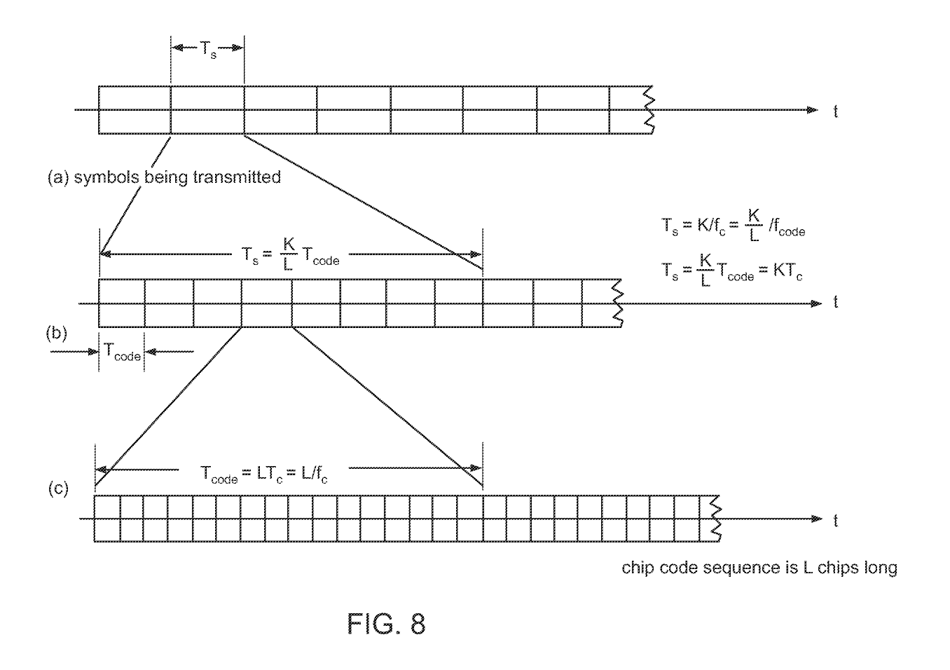

The chip code spreads the spectrum of the pilot signal. The direct sequence spread spectrum signals, c₁, . . . , c_{N}, used for the pilot signals are each spread using a chip code. The code rate is termed the chip rate to differentiate it from the data rate. The chip rate is f_{C}=f_{D}, which is equal to the available bandwidth B. Since there are N transmit antennas, N pilot codes (signals) are used. Each of the N codes is periodic with the same periodicity. In one design, each code is orthogonal to the other codes. Since a code is periodic, it can be represented by a Fourier series, that is, by a series of amplitudes and phases, each located at a frequency which is harmonically related to the fundamental frequency. If there are L chips in the code (i.e. length of code), then the amplitudes are located at the frequencies: f_{T}(u)=uf_{C}/L=uf_{D}/L, where u is an integer 1, 2 . . . L as illustrated in FIG. 6 where the subchannels formed by the IFFT are shown. Each subchannel has a bandwidth f_{D}/K. Since, f_{C}=f_{D} (the available bandwidth), there are L chips in a codeword, thus there are K/L codewords/symbol. The pilot signal is therefore seen to consist of frequency tones spaced f_{D}/L apart. If L=K, f_{T}=uf_{D}/K, a tone occurs at each of the OFDM sub channels. For this reason, L is selected to be approximately K/8, so that a pilot tone occurs once in every 8 subchannels. FIG. 7 shows the chip code repeating every L chips with K/L such repetitions occurring during each symbol. FIG. 8(a) shows the symbols being transmitted from the IFFT. FIG. 8(b) shows the duration of a codeword T_{code} repeated K/L times during each symbol. Thus, in one design, K/L should be an integer. FIG. 8(c) shows that there are L chips/codeword and K chips/symbol.

The present invention involves the insertion of the direct sequence spread spectrum pilot signals, c₁(t), . . . c_{N}(t), each having a chip rate f_{C}, after the spatial signals have been encoded by the IFFT, that is, at the output of the OFDM system thus providing synchronization and channel estimation which is much more accurate in a given time, than in the prior art.

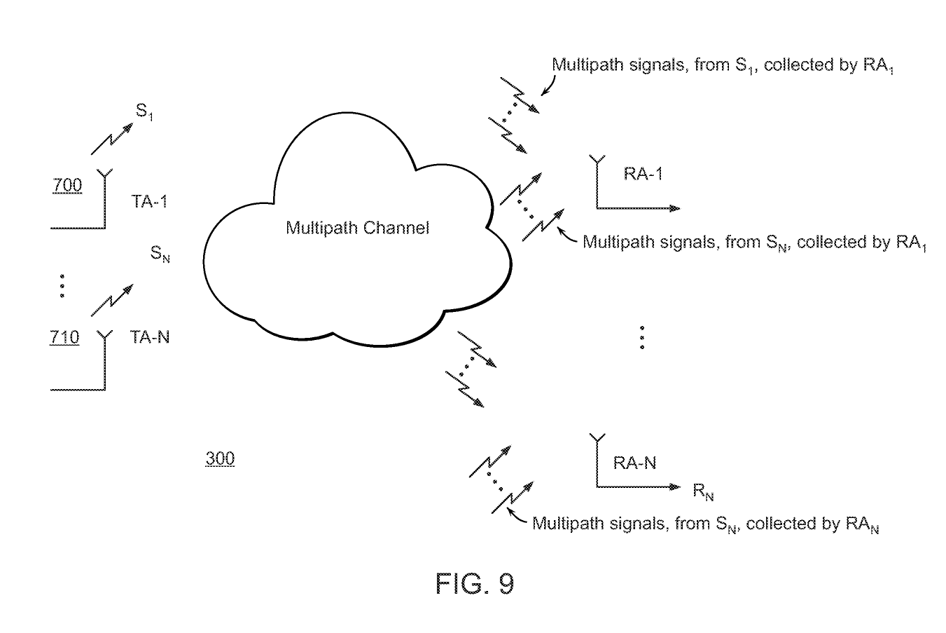

The multipath channel 300 is explained with reference to FIG. 9. The N transmitted signals each travel, for the most part, beyond line of sight. That is, the transmitter does not see the intended receiver. Also, each transmit antenna sends the same transmitted signal as multiple rays, along different paths, depending on the construction of the antenna. These signals are called multipath signals. The multipath signals, by taking different routes, are each partially absorbed and reflected from the surfaces they meet. Such surfaces can include buildings, cars, people, leaves, etc. As a result, some of the rays may be blocked and never reach the intended receiver. Others are delayed and attenuated relative to each other. Typically, relative delays do not exceed 1 μs (which corresponds to a differential distance of 300 meters). Also, typically, the longer the relative delay, the more the transmitted signal is attenuated and therefore loses importance relative to a signal received with significantly greater energy.

FIG. 9 illustrates the multipath signals being received by receive antennas RA1 and RAN. Each receive antenna can collect signals from all, or some, of the transmit antennas. The multipath signals from a particular transmit antenna often overlap one another in time when received, and these signals may cancel one another, referred to as multipath fading. It is not unusual to find a 20 dB fade extending over a bandwidth of several MHz.

The received signal at receive antenna RA1 is:

R₁=h₁₁s₁+h₁₂s₂+ 1.

where hᵢⱼ represents the channel attenuation and delay due to the path taken by each of the transmitted signals. In this case, i means receive antenna i and j means transmit antenna j.

If multipath occurs:

Rᵢ=ΣΣ(hᵢⱼₖ×sⱼₖ) 2.

where i is the particular receive antenna. j is the particular transmitter signal, and k is the multipath of the jth signal.

If the relative delays of the multipath signals are comparable, that is small compared to the symbol duration, and/or, if a RAKE (equalizer) is employed, the values of h can be considered to vary slightly during a symbol, and an equivalent hᵢⱼ can be employed to replace hᵢⱼₖ. The result simplifies to Eq 1:

$$\begin{matrix}{R}_{1} = {h}_{11} {s}_{1} + {h}_{12} {s}_{2} + … \\ {R}_{2} = {h}_{21} {s}_{1} + {h}_{22} {s}_{2} + … \\ …\end{matrix} \qquad 3.$$

Or, in matrix notation:

R=HS 4.

In each receiver R is measured. If the value of H is known, S could be calculated. However, the values of R that were measured contain noise, and the values of H change with time. Thus, to estimate the values of S, R is measured, H is estimated and then the received signals: Sₑₛₜ: S₁, s₂, . . . , are estimated by solving the simultaneous equations, given by Eq 4. In matrix form this can be written as:

Sₑₛₜ=H⁻¹R/H⁻¹H 5.

The problem is to first estimate H, which is a function of time. The present invention reliably estimates H on a symbol-to-symbol basis, that is, providing a new, reliable estimate of H during each symbol, thereby enabling the receiver to properly estimate the transmitted data. The prior art makes only one measurement of H during each symbol and therefore requires many symbols to estimate H. Alternately, the prior art requires a very slowly varying channel. In the present invention, the chip rate is much greater than the symbol rate and therefore the channel transfer function H can be accurately estimated during a single symbol. This is very important for rapidly varying channels, such as those encountered during the time that a user is mobile. To achieve this accurate estimation capability, the pilot signal is added to the OFDM signal after the IFFT encoding of the input data.

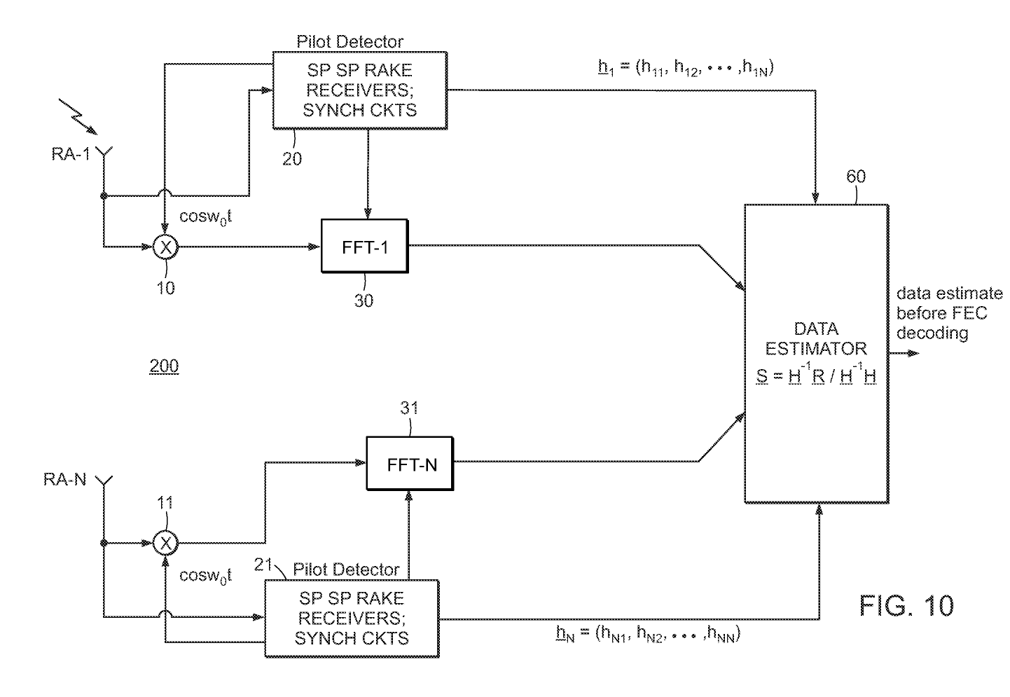

FIG. 10 illustrates a receiver 200 for the OFDM/MIMO system to undo the operations performed in the transmitter in order to estimate the transmitted data. In the receiver, the incoming signals are first detected by the N, receive antennas RA1 . . . RAN, and then down-converted, 10, 11. The pilot detectors, 20,21, detect the direct sequence spread spectrum pilot signals, and synchronize to the carrier frequency, f₀. The pilot detectors also synchronize to the incoming direct sequence codes (c₁, . . . , C_{N},) replicas of which are resident in the receiver. Essentially, the receiver separates a combination signal from each receive antenna into a received pilot signal and received OFDM encoded data signals. The received OFDM encoded data signals are supplied to FFTs 30, 31 along with inputs from pilot detectors 20, 21, such that the OFDM encoding is undone with the aid of the pilot detectors. Multiplexing results in a single stream of data which is an estimate of the transmitted data in data estimator 80. Synchronization procedures are well known in the art, and are not discussed herein.

Since the chip codes employed to spread spectrum modulate each pilot signal is known by the receiver, Eq 3 can be readily solved for the channel parameters H. To illustrate this process, assume that there are only two transmit and two receive antennas. Then, the transmitted signals are,

s₁(t)=m₁(t)+c₁(t), 6.

and

s₂(t)=m₂(t)+c₂(t), 7.

where m₁ and m₂ contain the data information. In one embodiment, the number of chips in the code is equal to L=K/8, which is the number of subchannels used by the chip code (The number 8=2³. Since the total number of subchannels used by the OFDM encoder is usually a multiple of 2, using 8 yields an integer number of subchannels used by the coder.) For example, if the total number of subchannels used by the encoder is K=256 (=2⁸), the number of chips in the code, before the code starts to repeat, is L=256/8=32 (=2⁵). There are then 8 subchannels used by the chip code. The symbol transmission time is T_{S}=K/f_{C}=K/f_{D}. During the symbol time, the pilot code, which repeats every T_{code}=L/f_{c}, is repeated K/L=8 times. Thus, in a preferred design, the entire chip code is repeated 8 times during a symbol. Hence, there are K=256 chips/symbol. Accordingly, the number of chips per symbol is equal to K, and the chip code enables an accurate estimation of the channel during the symbol time.

For the purpose of illustration, assume that the chip codes used are the Walsh Functions, and that L=8. Let c₁=W₁=11001100 . . . and c₂=W₂=10011001 . . . . Then, from Eqs 6 and 7:

R₁=h₁₁m₁+h₁₂m₂+h₁₁W₁+h₁₂W₂ 8.

and

R₂=h₂₁m₁+h₂₂m₂+h₂₁W₁+h₂₂W₂ 9.

The pilot detector, 20 multiplies received signal, R₁ by the stored codeword, W₁ and averages over the 8 Walsh function chips. The average value of W₁×W₂=0. In one design, in order to minimize interference, no data is transmitted in the subchannels occupied by the pilot code. Since R₁ is known, and M₁ and M₂ are each equal to zero in these subchannels:

h₁₁=avge(W₁×R₁) 10.

Similarly,

h₁₂=avge(W₂×R₁) 11.

Performing the same operations on R₂, yields:

h₂₁=avge(W₁×R₂) 12.

and

h₂₂=avge(W₂×R₂)

The averaging can occur not just over a single codeword, but over each pilot codeword in the symbol. Therefore, consider that:

W₁= . . . 1100110011001100 . . . ,

and that R₁ is a slowly varying function of time. Then, from time T₁ to T₈:

avge((11001100)×R₁(t)) 14.

From T₂ to T₉, that is starting one chip later the next average can be performed:

avge((10011001)×R₁(t)) 15.

Thus, the value of h₁₁ is updated at the chip rate. The other values of h are similarly determined and updated. These values of H are used in the data estimator 60, to determine the estimate of the transmitted data. Using the above procedure, the value of H is updated after every chip.

An alternative, simpler, approach could be used where the average is taken after each pilot codeword. Using this approach, with K/L=8, the transfer function H is estimated 8 times per symbol.

Accordingly, update of the channel parameters, H is “continual” in accordance with the present invention.

Equations 10, 11, 12, and 13 require that the average value of the pseudo random sequences, when multiplied by the received data streams is zero. Thus, in Eq 8, it is assumed that

avge(W₁×m₁)=0 and avge(W₁×m₂)=0 16.

As stated above, this is correct in the design where the signals are set to zero in the subchannels occupied by the data.

The present invention differs from the approach taken in the IEEE 802 standards, since in the present invention the chips change at the chip rate, while the data changes at the IFFT symbol rate. In the 802 Standards, the chips are input to the IFFT; and, therefore, the chips and the data each change at the symbol rate. Once each of the channel parameters, hᵢⱼ is known, equations 8 and 9 can be solved to obtain estimates for m₁ and m₂.

One approach to calculating m₁ and m₂ is to note that the pilot signal occupies specified subchannels. In one design, there is no signal present in those subchannels, and the FFT decoder can be designed not to decode those subchannels. In that case, Eqs 8 and 9 would be:

R₁=h₁₁m₁+h₁₂m₂

and

R₂=h₂₁m₁+h₂₂m₂

Knowing R₁, R₂, h₁₁, h₁₂, h₂₁, and h₂₂, m₁ and m₂ can be solved.
This process can be extended for the use of additional antennae in the transmitter and/or receiver.

An alternative, procedure, is to allow the data to reside in the channels corrupted by the chip code channels, but to use erasure codes to correct the resulting errors.

A still other approach is to note that since the chip code sequences are known, they can be subtracted from the received signals. In this case, Eqs 8 and 9 become:

R₁−h₁₁W₁−h₁₂W₂=h₁₁m₁+h₁₂m₂ 17.

And

R₂−h₂₁W₁−h₂₂W₂=h₂₁m₁+h₂₂m₂ 18.

Equations 17 and 18 are readily solved for m₁ and m₂. Further, such a solution can be readily extended using standard techniques to the use of additional antennae.

This last approach does not require the elimination of data channels, which decreases the data rate, nor does it require the use of punctured codes.

Note that the pilot signals (codes) are used for synchronization as well as to estimate the channel transfer function characteristics. As the synchronization and channel estimation are done at the code's chip level, not at the symbol level, such synchronization and estimation is much more accurate since the number of chips/symbol can be a large number, such as 256, as shown in the above example. One approach is to keep the number of subchannels occupied by the code equal to 10%-15% of the total number of subcarrier channels so that erasure codes and/or cancellation techniques can operate efficiently. The pseudo random sequence used to modulate the pilot signal has a chip rate, f_{C}, which, in one design, is equal to the available bandwidth B, of the transmitted signal. Thus, if the bandwidth is B=20 MHz wide, the chip rate, is f_{C}=B=20 Mchips/sec. This bandwidth is often approximately equal to the symbol rate before the IFFT, which is f_{D}.

There are K subchannels, each of bandwidth, f_{S}. Thus, the total available bandwidth is B=Kf_{S}. Thus, the symbol rate, f_{S}=B/K. The number of subchannels, K, is usually selected to be a power of 2. Thus, the number of subchannels is typically K=64, 128, 256, 1024, etc. The pseudo random sequence is characterized by the length of the pseudo random code, before it repeats. The length of an Orthogonal code is typically L=2^{v}, where v is an integer. The pilot signal, being modulated by a repetitive code is periodic, and therefore expandable into a Fourier Series consisting of L tones spaced by in frequency by f_{C}/L.

In one system design, the relation between L and K is then:

L is approx 10% to 15% of K 19.

For example, if the number of OFDM subchannels is 64, the length of the pseudo noise code is 8 chips/code. If the number of OFDM subchannels is 1024, the length of the pseudo noise code is preferably 128 chips/code. While other code lengths are usable, the above code length will provide increased immunity to multipath fading, good synchronization and good estimation of the channel transfer function.

In the case of 1024 subchannels, there are K=2¹⁰ symbols transmitted during the symbol duration T_{S}, with 128 subchannels shared with the pilot. During the symbol duration, the pilot transmits 1024 chips such that the code of length L is retransmitted K/L times during each symbol. The retransmission can occur by simply repeating the same code. As pointed out earlier, the transfer function can be calculated K/L times during each symbol thereby yielding an excellent characterization of the channel; a characterization not possible using the approaches presented in the 802 Standards, where the pseudo random code changes at the symbol rate. Accordingly, the present invention provides improvement, by a factor of K/L, in synchronization and in the almost continual estimation of the channel transfer function over the prior art.

The concept of the present invention of adding pilot signals to the output of an OFDM encoder (i.e. after encoding data/symbols) can be implemented as a transmitter, a receiver, a system and/or a method.

Inasmuch as the present invention is subject to many variations, modifications and changes in detail, it is intended that all subject matter discussed above or shown in the accompanying drawings be interpreted as illustrative only and not be taken in a limiting sense.

What is claimed is:

1. An OFDM/MIMO transmitter for use in a wireless communication system, said transmitter comprising
means for coding and interleaving data signals;
means for demultiplexing the coded and interleaved data signals to produce demultiplexed spatial signals;
an OFDM encoder arrangement receiving said demultiplexed spatial signals and generating a plurality of OFDM encoded signals;
a source generating pilot signals;
means adding said pilot signals to said OFDM encoded signals to produce transmit signals formed of said pilot signals added to said OFDM encoded signals; and
a plurality of antennas for transmitting said transmit signals, each of said antennas transmitting one of said transmit signals.

2. An OFDM/MIMO transmitter as recited in claim 1 wherein said OFDM encoder arrangement includes an IFFT encoder.

3. An OFDM/MIMO transmitter as recited in claim 2 wherein said pilot signals each have a different chip code and the same code length and the chip rate divided by the code length is greater than or equal to the subchannel bandwidth of the IFFT encoder.

4. An OFDM/MIMO transmitter as recited in claim 1 wherein said pilot signals are spread spectrum signals spread by a chip code for use in determining channel estimation and attenuation.

5. An OFDM/MIMO transmitter as recited in claim 4 wherein said OFDM encoded signals represent symbols transmitted at a symbol rate and said chip code has a chip rate less than or equal to the available bandwidth.

6. An OFDM wireless communication system comprising
an OFDM transmitter including circuitry for coding and interleaving data signals, a demultiplexer, demultiplexing the coded and interleaved data signals to form spatial signals, and OFDM encoders encoding each of the spatial signals, adders receiving each of the OFDM encoded spatial signals along with one of a set of substantially orthogonal pilot signals and an antenna to receive each of the OFDM encoded signals with the added pilot signals and to transmit the OFDM encoded signals and the added pilot signals over a fading multipath channel; and
a OFDM receiver including antennas receiving the OFDM signals with their added pilot signals, pilot detector means for detecting the pilot signals and synchronizing and determining channel parameters, a signal detector for estimating the data received at each antenna, a combiner for combining data received at each antenna and a multiplexer to multiplex the data received from each transmit antenna into a single data stream.

7. An OFDM transmitter for use in a wireless communication system comprising
an IFFT encoder having an input receiving a data signal and an output containing subchannels, a number of the subchannels carrying data and a number of the subchannels not carrying data;
a source generating a direct sequence spread spectrum pilot signal;
an adder coupled with said output of said IFFT encoder and with said source generating said direct sequence spread spectrum pilot signal for adding said direct sequence spread spectrum pilot signal to said IFFT output subchannels to produce a combination signal carrying data and said pilot signal; and
a transmit antenna for transmitting said combination signal.

8. An OFDM transmitter as recited in claim 7 and further comprising
at least one other IFFT encoder having an input receiving a data signal and an output containing subchannels, a number of the subchannels carrying data and a number of the subchannels not carrying data;
a source generating another direct sequence spread spectrum pilot signal;
an adder coupled with said output of said other IFFT encoder and with said source generating said another direct sequence spread spectrum pilot signal for adding said another direct sequence spread spectrum pilot signal to said other IFFT output subchannels to produce another combination signal carrying data and said another spread spectrum pilot signal; and
a plurality of transmit antennas for transmitting said combination signals.

9. An OFDM transmitter as recited in claim 8 wherein said spread spectrum pilot signals have a code length L which is equal to the number of subchannels not carrying data.

10. An OFDM receiver for use in a wireless communication system to receive an OFDM transmission containing a combination signal formed of an IFFT encoded signal added to a pilot signal, said OFDM receiver comprising
antenna means for receiving the combination signal;
pilot signal detector means receiving the pilot signals from the antenna means for detecting the pilot signal for synchronization and signal channel estimation; and
data detector means receiving the data carrying subchannels and aided by the pilot signal for detecting the data to undo the encoding.

11. An OFDM wireless communication method comprising the steps of
OFDM encoding data to be transmitted to produce OFDM encoded data signals;
adding a different pilot signal to each of the encoded data signals; and
transmitting the OFDM encoded data signals and the added pilot signal as a combined signal from a transmit antenna.

12. An OFDM wireless communication method as recited in claim 11 and further comprising the steps of
receiving the combined signal at a receive antenna;
separating the combined signal into received pilot signals and received OFDM encoded data signals;
detecting the received pilot signals for synchronization and signal channel estimation; and
detecting the OFDM encoded data signals to undo the encoding with the aid of the pilot signal detector to undo the encoding.

13. An OFDM wireless communication method as recited in claim 12 and further comprising the steps of
receiving the combined signal at each of a plurality of receive antennas;
combining the data signals from each receive antenna; and
multiplexing the resulting data signals to obtain a single stream of data which is an estimate of the transmitted data.
